(19) United States
(12) Patent Application Publication
(10) Pub. No.: US 2026/0073133 A1
(43) Pub. Date: Mar. 12, 2026

(54) COMPUTER SYSTEM, DIALOGUE PROCESSING METHOD, AND NON-TRANSITORY COMPUTER-READABLE STORAGE MEDIUM

(71) Applicant: Hitachi Solutions, Ltd., Tokyo (JP)

(72) Inventors: Nao HOTTA, Tokyo (JP); Takeshi TANAKA, Tokyo (JP); Masayoshi MASE, Tokyo (JP); Yuxin LIANG, Tokyo (JP); Hideto YAMAMOTO, Tokyo (JP); Naoya ISHIDA, Tokyo (JP)

(21) Appl. No.: 19/047,093

(22) Filed: Feb. 6, 2025

(30) Foreign Application Priority Data
Sep. 10, 2024 (JP) 2024-156666

(51) Int. Cl. G06F 40/20

(52) U.S. Cl. CPC G06F 40/20

(57) ABSTRACT

A computer system manages an ending condition that is set based on a satisfaction status of each of a plurality of evaluation items for determination of quality of information delivery in an answer to a question. The computer system outputs a first question to a user who is interviewed in a meeting, acquires an answer to the first question from the user, evaluates the satisfaction status of the evaluation items in the answer to the first question, outputs the evaluated satisfaction status as a first evaluation result, determines whether the ending condition is satisfied based on the first evaluation result, generates an additional question to satisfy the evaluation item not satisfied and outputs the additional question to the user when the ending condition is not satisfied, and ends accepting of answer input when the ending condition is satisfied.

### CLAIM OF PRIORITY

The present application claims priority from Japanese patent application JP 2024-156666 filed on Sep. 10, 2024, the content of which is hereby incorporated by reference into this application.

### BACKGROUND OF THE INVENTION

### 1. Field of the Invention

The present invention relates to a system for conducting a meeting.

### 2. Description of Related Art

As a technology for asking questions to acquire information from a person, a technology described in JP2004-45900A is known. JP2004-45900A discloses “an audio dialogue apparatus configured to, in order to obtain a target answer from a speaker in at least one slot provided for each of multiple different categories, output through sound a guidance sentence targeted at at least one category, and confirm the target answer by analyzing an answer sentence obtained from the speaker in response to the guidance, the audio dialogue apparatus including a keyword detection unit and a dialogue controller, the keyword detection unit detecting, from the answer sentence, a slot word or phrase including a candidate for a slot value of the category asked in the guidance sentence, a slot word or phrase including a candidate for a slot value for a slot of a category different from the category asked in the guidance sentence, and a command word or phrase including a word representing “positive” or “negative”, the dialogue controller controlling, when all the slots are not confirmed, a guidance sentence to demand an answer to a slot of a category to be confirmed”.

### SUMMARY OF THE INVENTION

Systems for conducting meetings have appeared in recent years. In a meeting, questions are asked to acquire information necessary for evaluation of an evaluatee through dialogue therewith, and the questions need to be ended at an appropriate timing.

With the technology described in JP2004-45900A, it is difficult to end questions at an appropriate timing.

An object of the present invention is to realize a meeting system for asking various questions corresponding to an answer of an evaluatee, and ending questions at an appropriate timing.

A representative example of the invention disclosed in the present application is as follows. A computer system includes a processor and a storage medium connected to the processor. The computer system manages an ending condition that is set based on a satisfaction status of each of a plurality of evaluation items for determination of quality of information delivery in an answer to a question. The processor outputs a first question to a user who is interviewed in a meeting, acquires an answer to the first question from the user, evaluates the satisfaction status of each of the plurality of evaluation items in the answer to the first question and outputs the evaluated satisfaction status as a first evaluation result, determines whether the ending condition is satisfied based on the first evaluation result, when the ending condition is not satisfied, generates an additional question to satisfy the evaluation item not satisfied and outputs the additional question to the user, and when the ending condition is satisfied, ends accepting of answer input.

According to the present invention, various questions can be asked corresponding to an answer of an evaluatee, and questions can be ended at an appropriate timing. A problem, a configuration, and an effect other than those describe above will be apparent from the following description of an embodiment.

### BRIEF DESCRIPTION OF THE DRAWINGS

FIG. 1 is a diagram illustrating one example of a configuration of a system of Embodiment 1.

FIG. 2 is a chart illustrating one example of a data structure of a personal history information DB of Embodiment 1.

FIG. 3 is a chart illustrating one example of a data structure of a question list DB of Embodiment 1.

FIG. 4 is a chart illustrating one example of a data structure of an evaluation policy DB of Embodiment 1.

FIG. 5A is a chart illustrating one example of a data structure of an answer DB of Embodiment 1.

FIG. 5B is a chart illustrating one example of a data structure of an answer DB of Embodiment 1.

FIG. 6A is a chart illustrating one example of a data structure of a meeting evaluation result DB of Embodiment 1.

FIG. 6B is a chart illustrating one example of a data structure of a meeting evaluation result DB of Embodiment 1.

FIG. 7 is a flowchart for explaining one example of evaluation policy setting processing that is executed by a meeting apparatus of Embodiment 1.

FIG. 8A is a diagram illustrating one example of an interface provided to a terminal (evaluator) of Embodiment 1.

FIG. 8B is a diagram illustrating one example of an interface provided to the terminal (evaluator) of Embodiment 1.

FIG. 9 is a flowchart for explaining one example of question-list generating processing that is executed by the meeting apparatus of Embodiment 1.

FIG. 10 is a diagram illustrating one example of an interface provided to the terminal (evaluator) of Embodiment 1.

FIG. 11 is a flowchart for explaining one example of meeting processing that is executed by the meeting apparatus of Embodiment 1.

FIG. 12 is a diagram illustrating one example of an interface provided to a terminal (evaluatee) of Embodiment 1.

FIG. 13 is a flowchart for explaining one example of first-question generating processing that is executed by the meeting apparatus of Embodiment 1.

FIG. 14 is a flowchart for explaining one example of answer evaluating processing that is executed by the meeting apparatus of Embodiment 1.

FIG. 15 is a diagram illustrating one example of a prompt that is generated by the meeting apparatus of Embodiment 1.

FIG. 16 is a flowchart for explaining one example of additional-question generating processing that is executed by the meeting apparatus of Embodiment 1.

FIG. 17 is a diagram illustrating one example of a prompt that s generated by the meeting apparatus of Embodiment 1.

FIG. 18 is a flowchart for explaining one example of meeting evaluating processing that is executed by the meeting apparatus of Embodiment 1.

FIG. 19 is a diagram illustrating one example of an interface provided to the terminal (evaluatee) of Embodiment 1.

FIG. 20 is a diagram illustrating one example of an interface provided to the terminal (evaluator) of Embodiment 1.

### DESCRIPTION OF EMBODIMENT

Hereinafter, an embodiment of the present invention is described with reference to the drawings. However, the invention is not to be construed as being limited to description contents of the embodiment described below. It is easily understood for a person skilled in the art that specific configurations of the embodiment can be changed without departing from the idea or spirit of the invention.

In the following description of configurations of the invention, the same or similar configurations or functions are denoted by the same reference characters to omit redundant description.

Examples of various types of information may be described by using expressions such as “table”, “list”, and “queue”, but various types of information may be expressed in a data structure other than the above expressions. For example, various types of information such as “XX table”, “XX list”, and “XX queue” may be “XX information”. In describing identification information, expressions such as “identification information”, “identifier”, “name”, “ID”, and “number” are used, but these expressions can be replaced with each other.

The notations such as “first”, “second”, and “third” in this specification and the like are given to identify components, and do not necessarily limit the number or order.

The position, size, shape, range, and the like of each configuration shown in the drawings and the like may not represent the actual position, size, shape, range, and the like in order to facilitate understanding of the invention. Therefore, the invention is not limited to the positions, sizes, shapes, ranges, and the like disclosed in the drawings and the like.

### Embodiment 1

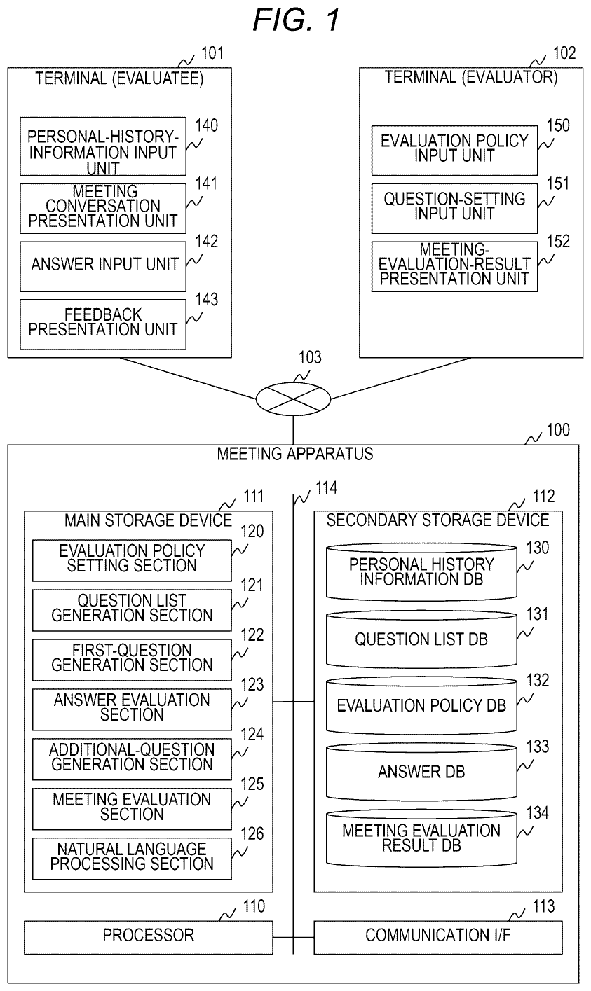

FIG. 1 is a diagram illustrating one example of a configuration of a system of Embodiment 1. An embodiment describes an example in which an interview is taken as one example of a meeting.

The system includes a meeting apparatus 100, a terminal (evaluatee) 101, and a terminal (evaluator) 102. The meeting apparatus 100, the terminal (evaluatee) 101, and the terminal (evaluator) 102 are connected to one another via a network 103 such as a local area network (LAN). A connection method of the network 103 may be either wired or wireless.

The terminal (evaluatee) 101 is a terminal that is operated by an evaluatee who is interviewed in a meeting. The terminal (evaluator) 102 is a terminal that is operated by an evaluator (for example, a company) who conducts a meeting. Each of the terminal (evaluatee) 101 and the terminal (evaluator) 102 is, for example, a general purpose computer, a smart phone, a tablet terminal, or the like.

The terminal (evaluatee) 101 includes a personal-history-information input unit 140, a meeting conversation presentation unit 141, an answer input unit 142, and a feedback presentation unit 143.

The personal-history-information input unit 140 provides an interface to input personal history information. The meeting conversation presentation unit 141 provides an interface to display conversation in a meeting. The answer input unit 142 provides an interface to input an answer to a question. The feedback presentation unit 143 provides an interface to display feedback information with respect to a conduction result of a meeting.

The terminal (evaluator) 102 includes an evaluation policy input unit 150, a question-setting input unit 151, and a meeting-evaluation-result presentation unit 152.

The evaluation policy input unit 150 provides an interface to input an evaluation policy for an evaluatee in a meeting. The question-setting input unit 151 provides an interface to input information for generating a question. The meeting-evaluation-result presentation unit 152 provides an interface to display meeting evaluation.

The meeting apparatus 100 includes a processor 110, a main storage device 111, a secondary storage device 112, and a communication I/F 113. The respective hardware components are connected to one another via a bus 114. Note that the meeting apparatus 100 may include an input device, such as a keyboard, a mouse, and a touch panel, and an output device, such as a display.

The processor 110 executes a program stored in the main storage device 111. The processor 110 executes processing in accordance with the program to operate as a functional section (module) that implements a specific function. In the following description, when processing is described using a functional section as a subject, it is meant that the processor 110 executes the program that implements the functional section.

The main storage device 111 is a memory or the like and stores the program to be executed by the processor 110 and information to be used by the program. The main storage device 111 is also used as a work area.

The main storage device 111 of Embodiment 1 stores programs to implement an evaluation policy setting section 120, a question list generation section 121, a first-question generation section 122, an answer evaluation section 123, an additional-question generation section 124, a meeting evaluation section 125, and a natural language processing section 126.

The evaluation policy setting section 120 sets an evaluation policy for an evaluatee in a meeting. The question list generation section 121 generates a question list of questions to be asked in a meeting. The first-question generation section 122 generates, based on the question list, a question (first question) for evaluation of an arbitrary evaluation point. The additional-question generation section 124 generates a question (additional question) for evaluation of an arbitrary evaluation point. As will be described later, when an answer to the first question lacks information, the meeting apparatus 100 outputs the additional question to acquire the lacking information.

In the following description, the question stored in the question list is referred to as a reference question. The question generated by the first-question generation section 122 is referred to as the first question. Moreover, the question generated by the additional-question generation section 124 is referred to as the additional question. When the first question and the additional question are not distinguished from one another, they are referred to as a question.

The answer evaluation section 123 evaluates a satisfaction status of evaluation items for determination of quality of information delivery in an answer to a question, and records the evaluation result as an answer evaluation result. The meeting evaluation section 125 evaluates a meeting and records the evaluation result as a meeting evaluation result.

The natural language processing section 126 accepts a prompt including task contents, such as a question written in a natural language, understands the task contents, and generates and outputs answer text. In this embodiment, the meeting apparatus 100 includes the natural language processing section 126. However, an external device or an external system may include the natural language processing section 126.

Note that, with respect to the functional sections included in the meeting apparatus 100, a plurality of functional sections may be integrated into one functional section, or one functional section may be divided into a plurality of functional sections for the respective functions.

The secondary storage device 112 is a hard disk drive (HDD), a solid state drive (SSD), or the like, and is a mass storage device. The program or information stored in the main storage device 111 may be stored in the secondary storage device 112. In this case, the processor 110 reads the program and information from the secondary storage device 112 and loads them to the main storage device 111.

The secondary storage device 112 of Embodiment 1 stores a personal history information DB 130, a question list DB 131, an evaluation policy DB 132, an answer DB 133, and a meeting evaluation result DB 134.

The communication I/F 113 is an interface for connection with the network 103.

Next, details of the databases managed by the meeting apparatus 100 are described.

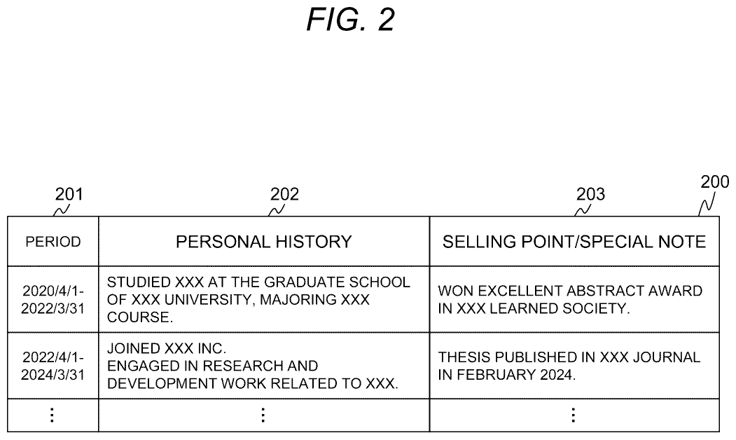

FIG. 2 is a chart illustrating one example of a data structure of the personal history information DB 130 of Embodiment 1.

The personal history information DB 130 is a database to manage personal history information of an evaluatee. The personal history information DB 130 stores a table 200 as illustrated in FIG. 2 on a per evaluatee basis. The table 200 corresponds to the personal history information. The personal history information is input via the personal-history-information input unit 140.

The table 200 stores an entry including a period 201, a personal history 202, and a selling point/special note 203. One entry corresponds to one personal history.

The period 201 is a fields that stores a period. The personal history 202 is a field that stores a specific content of the personal history. The selling point/special note 203 is a field that stores a selling point or a special note regarding a personal history.

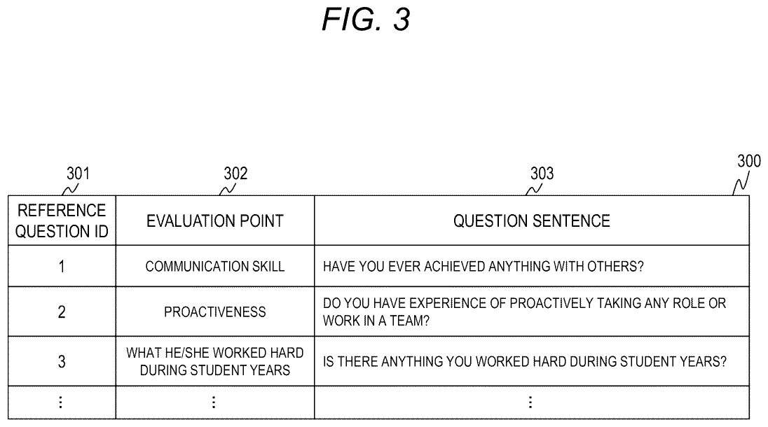

FIG. 3 is a chart illustrating one example of a data structure of the question list DB 131 of Embodiment 1.

The question list DB 131 is a database to manage a reference question list. The question list DB 131 stores a table 300 as illustrated in FIG. 3 on a per evaluator basis. The table 300 corresponds to the question list.

The table 300 stores an entry including a reference question ID 301, an evaluation point 302, and a question 303. One entry corresponds to one reference question.

The reference question ID 301 is a field to store an ID of the reference question. The evaluation point 302 is a field to store an evaluation point of an evaluatee in a meeting. The question 303 is a field to store the reference question. In the question 303, the reference question is stored in text form.

In this embodiment, one reference question exists for one evaluation point. In this embodiment, by outputting the first question that is generated from the reference question related to one evaluation point, the meeting apparatus 100 starts evaluation for the concerned evaluation point, and outputs the additional question until an ending condition is satisfied. When the ending condition is satisfied, the meeting apparatus 100 ends the evaluation related to the concerned evaluation point, and starts evaluation related to a new evaluation point.

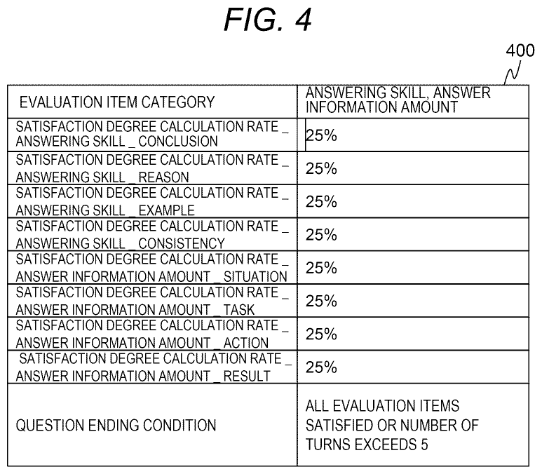

FIG. 4 is a chart illustrating one example of a data structure of an evaluation policy DB 132 of Embodiment 1.

The evaluation policy DB 132 is a database to manage an evaluation policy for an evaluatee in a meeting. The evaluation policy DB 132 stores a table 400 as illustrated in FIG. 4 on a per evaluatee basis. The table 400 corresponds to the evaluation policy.

The evaluation policy includes an evaluation category, evaluation item importance, and the ending condition. In the table 400 illustrated in FIG. 4, a first entry is a setting related to the evaluation category, second to ninth entries are settings related to the evaluation item importance, and a tenth entry is a setting related to the ending condition.

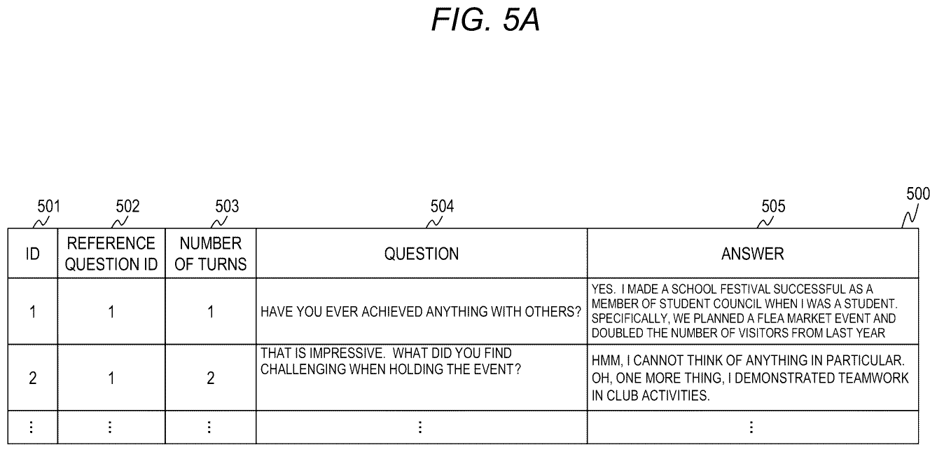

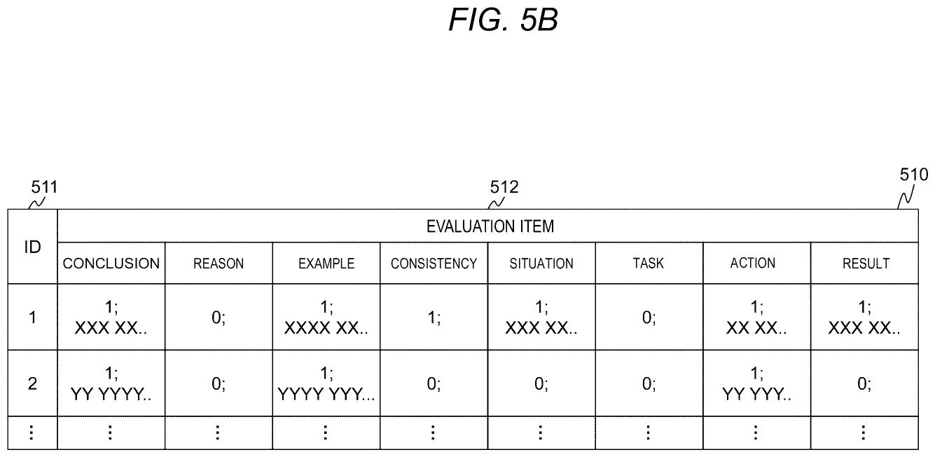

FIGS. 5A and 5B are charts illustrating one example of a data structure of the answer DB 133 of Embodiment 1. The answer DB 133 is a database to manage an answer of an evaluatee. The answer DB 133 stores a table 500 and a table 510 on a per evaluator-and-evaluatee pair basis.

The table 500 is a table to manage an answer to a question. The table 500 stores an entry including an ID 501, a reference question ID 502, a number of turns 503, a question 504, and an answer 505. One entry exists for a question-and-answer pair.

The ID 501 is a field that stores an ID of the entry. The reference question ID 502 is a field the same as the reference question ID 301. The reference question ID 502 makes it possible to grasp the evaluation point to which evaluation is related. The number of turns 503 is a field that stores a number of questions in evaluation related to one evaluation point. The question 504 is a field that stores a question. The answer 505 is a field that stores an answer to a question.

The table 510 is a table to manage an answer evaluation result. The table 510 stores an entry including an ID 511 and an evaluation item 512. One entry exists for a question-and-answer pair.

The ID 511 is a field the same as the ID 501. The evaluation item 512 is a field group that stores the answer evaluation result.

The meeting apparatus 100 of this embodiment determines whether an answer satisfies an evaluation item. When the answer satisfies the evaluation item corresponding to the field, the field stores a field value “1” and information (text) extracted from the answer. When the answer does not satisfy the evaluation item corresponding to the field, the field stores a field value “0”.

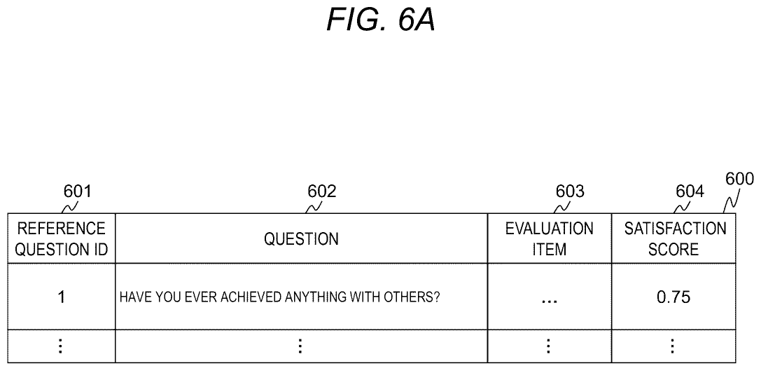

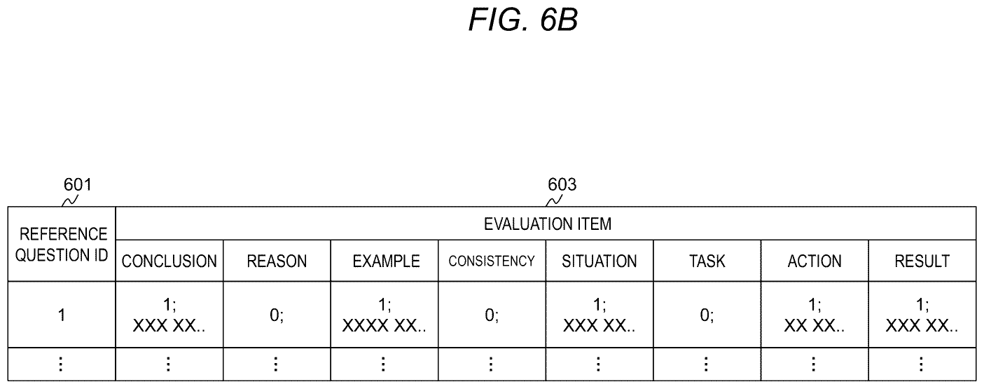

FIGS. 6A and 6B are charts illustrating one example of a data structure of the meeting evaluation result DB 134 of Embodiment 1.

The meeting evaluation result DB 134 is a database to manage a meeting evaluation result. The meeting evaluation result DB 134 stores a table 600 on a per evaluator-and-evaluatee pair basis. Note that the table 600 is illustrated in two divided drawings due to blank space of the chart.

Table 600 stores an entry including a reference question ID 601, a question 602, an evaluation item 603, and a satisfaction score 604. One entry exists for one evaluation point.

The reference question ID 601 is a field the same as the reference question ID 301. The question 602 is a field that stores the first question corresponding to the reference question ID 601. The evaluation item 603 is a field group that stores an evaluation result (meeting evaluation result) of the satisfaction status of the evaluation item in an answer to a question of one evaluation point. The satisfaction score 604 is a field that stores a score representing a degree of satisfaction of the evaluation items in an answer to a question of one evaluation point. The score is calculated by using the following mathematical formula, for example.

$$\begin{matrix}[ Math 1 ] & \\ {\sum }_{i} {α}_{i} {x}_{i} & ( 1 )\end{matrix}$$

Here, a subscript i is an identifier of the evaluation item, α is weight, and x is the field value.

Next, details of processing in the system are described.

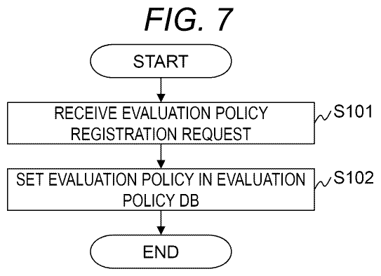

An evaluatee inputs in advance personal history information to the meeting apparatus 100 via the personal-history-information input unit 140 of the terminal (evaluatee) 101. In order to conduct a meeting, an evaluator registers the evaluation policy and the question list. Processing to register the evaluation policy and the question list is described with reference to FIGS. 7 to 10.

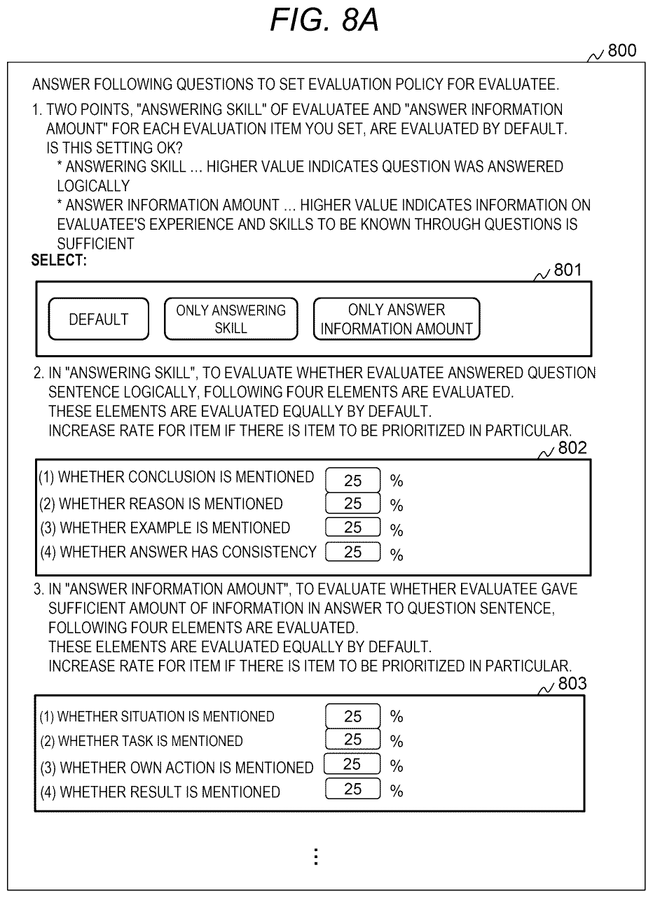

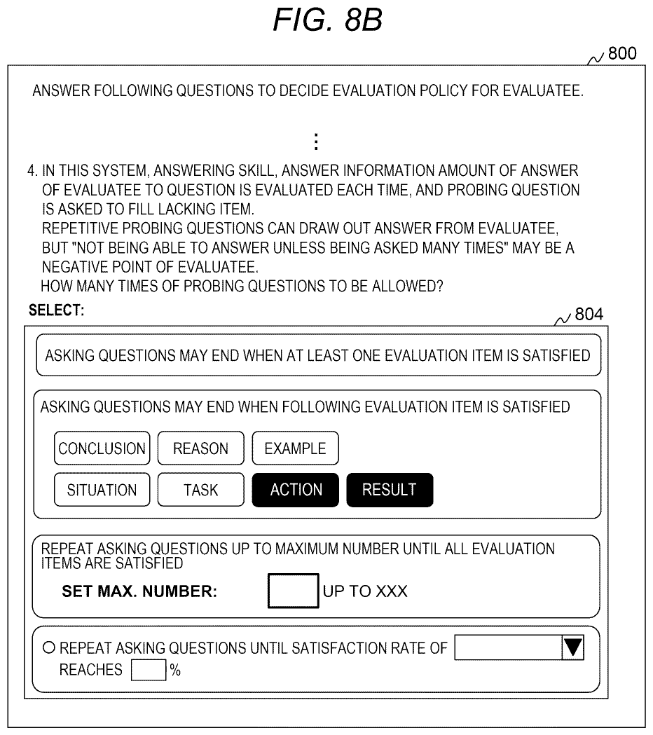

FIG. 7 is a flowchart for explaining one example of evaluation policy setting processing that is executed by the meeting apparatus 100 of Embodiment 1. FIGS. 8A and 8B are diagrams illustrating one example of an interface provided to the terminal (evaluator) 102 of Embodiment 1.

When the evaluation policy input unit 150 of the terminal (evaluator) 102 accepts operation from the evaluator, the evaluation policy input unit 150 displays a screen 800 as illustrated in FIGS. 8A and 8B. The screen 800 includes setting ranges 801, 802, 803, and 804.

The setting range 801 is a range to select the evaluation category. In this embodiment, there are two evaluation categories, which are “Answering skill” and “Answer information amount”.

“Answering skill” is an evaluation category in accordance with the STAR method. “Answering skill” includes four evaluation items, which are “Conclusion”, “Reason”, “Example”, and “Consistency”. With respect to “Conclusion”, when an answer includes information on a conclusion, “Conclusion” is determined to be satisfied. “Reason” and “Example” are also determined in a similar manner. With respect to “Consistency”, when one and the previous answers have consistency, “Consistency” is determined to be satisfied.

“Answer information amount” is an evaluation category in accordance with the PREP method. “Answer information amount” includes four evaluation items, which are “Situation”, “Task”, “Action”, and “Result”. With respect to “Situation”, when an answer includes information on a situation, “Situation” is determined to be satisfied. “Task”, “Action”, and “Result” are also determined in a similar manner.

The setting range 802 is a range to set weight for the evaluation items included in “Answering skill”. The setting range 803 is a range to set weight for the evaluation items included in “Answer information amount”. The weight is adjusted in such a manner as to be 100% in total.

The setting range 804 is a range to set the ending condition for evaluation of one evaluation point. FIG. 8B illustrates four types of ending conditions, and the evaluator selects any of the ending conditions.

A first ending condition is that when at least one evaluation item included in a selected evaluation category is satisfied, evaluation ends. A second ending condition is that when a selected evaluation item is satisfied, evaluation ends. A third ending condition is that when all the evaluation items are satisfied or the number of turns reaches the maximum number, evaluation ends. A fourth ending condition is that when a satisfaction rate is at a threshold or more, evaluation ends. The satisfaction rate is a percentage of satisfied evaluation items.

The evaluator inputs information on the evaluation policy by operating the screen 800 and sends registration request to the meeting apparatus 100.

The evaluation policy setting section 120 of the meeting apparatus 100 receives the evaluation policy registration request from the evaluation policy input unit 150 of the terminal (evaluator) 102 (Step S101).

The evaluation policy setting section 120 registers the evaluation policy included in the registration request (Step S102), and then ends the evaluation policy setting processing. Specifically, the evaluation policy setting section 120 generates the table 400 representing the evaluation policy included in the registration request, and stores the generated table 400 in the evaluation policy DB 132.

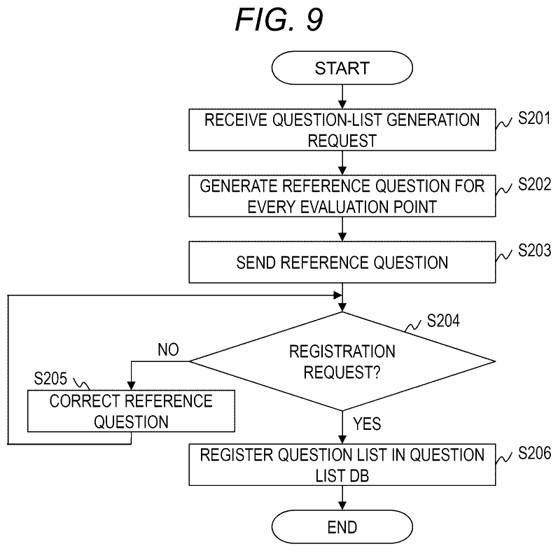

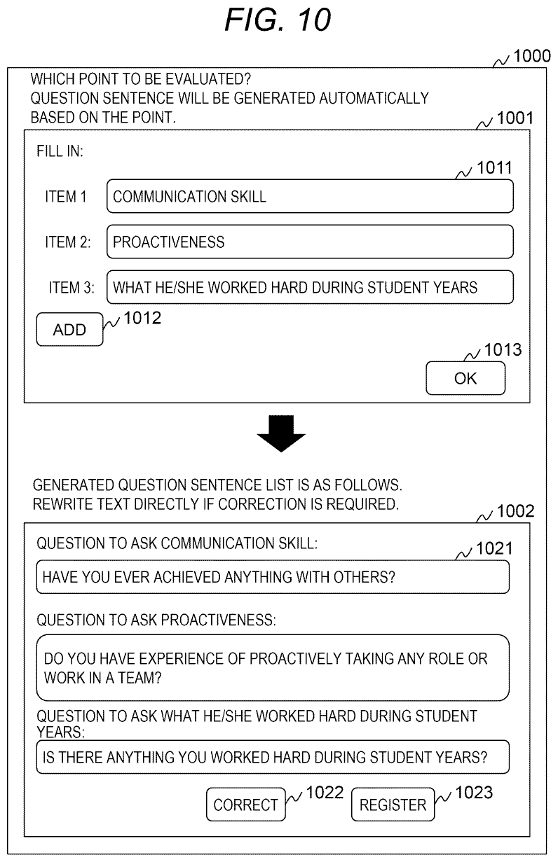

FIG. 9 is a flowchart for explaining one example of question-list generating processing that is executed by the meeting apparatus 100 of Embodiment 1. FIG. 10 is a diagram illustrating one example of an interface provided to the terminal (evaluator) 102 of Embodiment 1.

When the question-setting input unit 151 of the terminal (evaluator) 102 accepts operation from the evaluator, the question-setting input unit 151 displays a screen 1000 as illustrated in FIG. 10. The screen 1000 includes a setting range 1001 and an output range 1002.

The setting range 1001 is a range to set the evaluation point. The setting range 1001 displays a box 1011, an Add button 1012, and an OK button 1013. The box 1011 is a box to set the evaluation point. The Add button 1012 is a button to add the box 1011. The OK button 1013 is a button to output question-list generation request.

The output range 1002 is a range to display the generated reference question. The output range 1002 displays a box 1021, a correction button 1022, and a registration button 1023. The box 1021 is a box to display the reference question. The evaluator can correct the reference question in the box 1021 as appropriate. The correction button 1022 is a button to output reference-question correction request. When the correction button 1022 is operated, the reference-question correction request including a correction content is outputted. The registration button 1023 is a button to output question-list registration request.

The evaluator inputs the evaluation point by operating the screen 1000 and sends the question-list generation request to the meeting apparatus 100.

The question list generation section 121 of the meeting apparatus 100 receives the question-list generation request from the question-setting input unit 151 of the terminal (evaluator) 102 (Step S201).

The question list generation section 121 generates the reference question for every evaluation point included in the question-list generation request (Step S202). A conceivable method for generating the reference question includes a method as described below.

(1) Information in which the evaluation point and a question template are associated with one another is set in advance in the meeting apparatus 100. The question list generation section 121 generates the reference question for each evaluation point with reference to the set information.

(2) The question list generation section 121 generates a prompt including the evaluation point and a reference-question generation instruction. The question list generation section 121 inputs the prompt to the natural language processing section 126 and acquires answer text including the reference question.

The question list generation section 121 sends the generated reference question to the terminal (evaluator) 102 (Step S203). Then, the question list generation section 121 waits for operation by the evaluator. The question-setting input unit 151 of the terminal (evaluator) 102 displays the reference question in the output range 1002 of the screen 1000.

The question list generation section 121 determines whether request received from the terminal (evaluator) 102 is reference-question registration request (Step S204).

If the request received from the terminal (evaluator) 102 is the reference-question correction request, the question list generation section 121 corrects the reference question in accordance with a correction content included in the reference-question correction request (Step S205). Then, the question list generation section 121 waits for operation by the evaluator.

If the request received from the terminal (evaluator) 102 is the reference-question registration request, the question list generation section 121 registers in the question list DB 131 the question list (table 300) composed of the generated reference question (Step S206), and then ends the question-list generating processing.

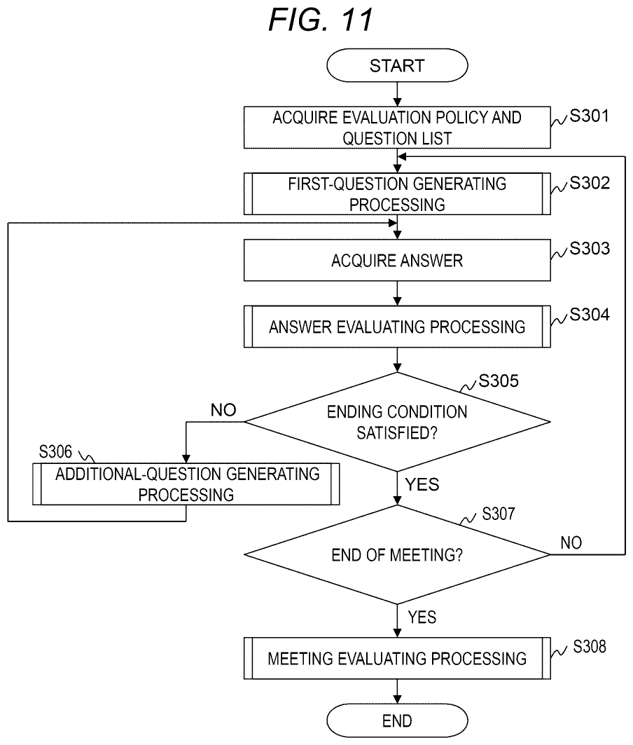

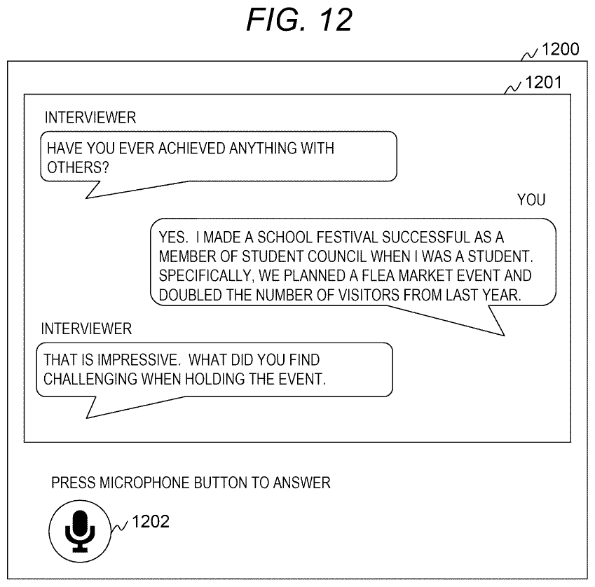

Next, meeting processing executed by the meeting apparatus 100 is described. FIG. 11 is a flowchart for explaining one example of the meeting processing that is executed by the meeting apparatus 100 of Embodiment 1. FIG. 12 is a diagram illustrating one example of an interface provided to the terminal (evaluatee) 101 of Embodiment 1.

The meeting conversation presentation unit 141 of the terminal (evaluatee) 101 accesses the meeting apparatus 100, selects a meeting to be conducted, that is, an evaluator, and requests a start of the meeting. At this time, the meeting apparatus 100 displays a screen 1200 as illustrated in FIG. 12 via the meeting conversation presentation unit 141. The screen 1200 includes a display range 1201 and a record button 1202.

The display range 1201 is a range to display a question and an answer. The record button 1202 is a button to input voice or sound as an answer. An evaluatee presses the record button 1202 to input voice or sound. Note that the answer may be input in text form.

When the meeting apparatus 100 accepts access from the terminal (evaluatee) 101, the meeting apparatus 100 starts the meeting processing.

The meeting apparatus 100 acquires the evaluation policy and the question list corresponding to the selected evaluator (Step S301). Specifically, the meeting apparatus 100 acquires the evaluation policy (table 400) for the selected evaluator from the evaluation policy DB 132, and acquires the question list (table 300) for the selected evaluator from the question list DB 131. At this time, the meeting apparatus 100 generates the tables 500, 510, and 600 provided with identification information of the evaluator and evaluatee.

First, the first-question generation section 122 of the meeting apparatus 100 executes first-question generating processing (Step S302). In the first-question generating processing, the first question is generated based on the question list, and the generated first question is output to the terminal (evaluatee) 101. Details of the first-question generating processing will be described later.

The meeting apparatus 100 acquires an answer to the question from the terminal (evaluatee) 101 (Step S303).

The answer evaluation section 123 of the meeting apparatus 100 executes answer evaluating processing (Step S304). In the answer evaluating processing, the satisfaction status of the evaluation item in the answer is evaluated. Details of the answer evaluating processing will be described later.

The answer evaluation section 123 of the meeting apparatus 100 determines whether the ending condition is satisfied based on the result of the answer evaluating processing (Step S305).

If the ending condition is not satisfied, the additional-question generation section 124 of the meeting apparatus 100 executes additional-question generating processing (Step S306), and then returns to Step S303. In the additional-question generating processing, the additional question is generated based on the answer and the answer evaluation result, and the generated additional question is output to the terminal (evaluatee) 101. Details of the additional-question generating processing will be described later.

If the ending condition is satisfied, the meeting apparatus 100 determines whether to end the meeting (Step S307). For example, the meeting apparatus 100 determines whether all the reference questions in the question list are output. Moreover, the meeting apparatus 100 may end the meeting when the meeting apparatus 100 accepts ending request from the evaluatee.

If the meeting continues, the meeting apparatus 100 returns to Step S302. If the meeting ends, the meeting evaluation section 125 of the meeting apparatus 100 executes meeting evaluating processing (Step S308). Then, the meeting apparatus 100 ends the meeting processing. In the meeting evaluating processing, meeting evaluation is performed. Details of the meeting evaluating processing will be described later.

As described with respect to FIG. 11, the meeting apparatus 100 can evaluate the satisfaction status of the evaluation item in the answer, and generate the additional question or end the evaluation related to the evaluation point based on the ending condition defined by using the satisfaction status.

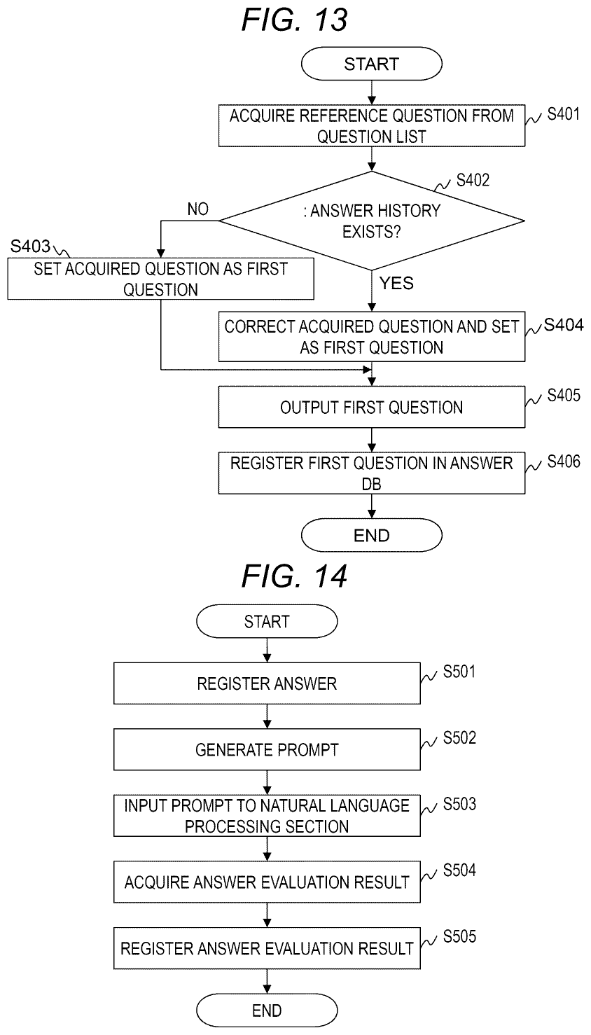

FIG. 13 is a flowchart for explaining one example of the first-question generating processing that is executed by the meeting apparatus 100 of Embodiment 1.

The first-question generation section 122 acquires the reference question from the question list (Step S401). The invention is not limited by a method for selecting the reference question. For example, the first-question generation section 122 may select the reference question in order from a top of the question list, or may select the reference question in a random manner. At this time, the first-question generation section 122 stores in the work area the ID (reference question ID) of the selected reference question.

The first-question generation section 122 determines whether the answer DB 133 stores an answer history (Step S402).

Specifically, the first-question generation section 122 determines whether the table 500 includes at least one entry. If the table 500 does not store any entry, the acquired reference question is meant to be an initial, first question in the meeting.

If the answer DB 133 does not store the answer history, the first-question generation section 122 sets the acquired reference question as the first question (Step S403). Then, the first-question generation section 122 proceeds to Step S405.

If the answer DB 133 stores the answer history, the first-question section 122 generation corrects the reference question based on the answer evaluation result of another evaluation point and the evaluation policy, and sets the corrected reference question as the first question (Step S404). Then, the first-question generation section 122 proceeds to Step S405.

For example, the first-question generation section 122 generates a prompt including the reference question, the answer evaluation result (an entry of the table 510) of the last evaluation point, the evaluation policy, and a correction instruction of the reference question. The first-question generation section 122 inputs the prompt to the natural language processing section 126 and acquires answer text including the corrected reference question. Note that the prompt may include the personal history information.

For example, in a conceivable method, the reference question is corrected in such a manner as to facilitate satisfaction of an unsatisfied evaluation item in the last evaluation point. For example, when “Conclusion” is not satisfied, the reference question is corrected so as to actively confirm “Conclusion” in an answer.

Note that correcting the reference question is a concept including not only correcting the reference question itself, but also adding a question to the reference question.

The first-question generation section 122 outputs the first question to the terminal (evaluatee) 101 (Step S405). The meeting conversation presentation unit 141 of the terminal (evaluatee) 101 displays the first question in the display range 1201 of the screen 1200. Note that the meeting conversation presentation unit 141 may output the first question as voice or sound.

The first-question generation section 122 registers the first question in the answer DB 133 (Step S406). Then, the first-question generation section 122 ends the first-question generating processing.

Specifically, the first-question generation section 122 adds an entry to the table 500 associated with the evaluator-and-evaluatee pair, and sets an arbitrary ID as the ID 501. Moreover, the first-question generation section 122 sets a reference question ID as the reference question ID 502 of the entry, sets “1” as the number of turns 503, and sets the first question as the question 504. At this time, the first-question generation section 122 stores in the work area the ID (entry ID) set as the ID 501 of the entry.

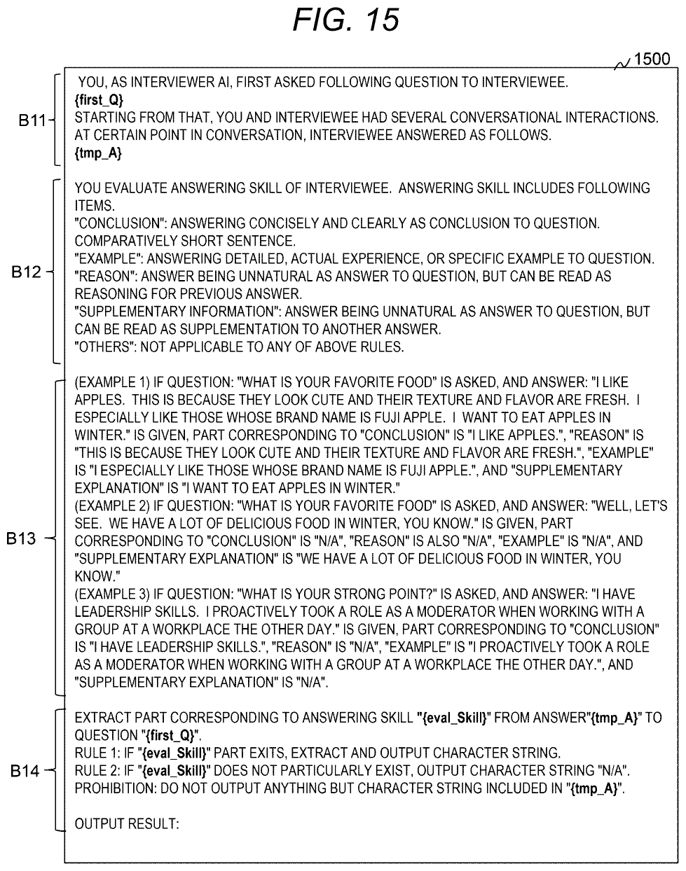

FIG. 14 is a flowchart for explaining one example of the answer evaluating processing that is executed by the meeting apparatus 100 of Embodiment 1. FIG. 15 is a diagram illustrating one example of a prompt that is generated by the meeting apparatus 100 of Embodiment 1.

The answer evaluation section 123 registers acquired answer in the answer DB 133 (Step S501).

Specifically, the answer evaluation section 123 sets, with reference to the table 500, the acquired answer as the answer 505 of the entry having the ID 501 that has been set to the entry ID stored in the work area.

The answer evaluation section 123 generates a prompt to instruct evaluation of the satisfaction status of the evaluation item in the answer in accordance with the evaluation policy (Step S502).

For example, a prompt 1500 as illustrated in FIG. 15 is generated. The prompt 1500 can be divided into four blocks B11, B12, B13, and B14. The block B11 is a block where a question and an answer are input. The block B12 is a block where the evaluation item to be evaluated is explained. The block B13 is a block where an evaluation case example is described. Contents of the blocks B12 and B13 are changed in accordance with the evaluation policy. The block B14 is a block where contents of an evaluation task are described.

The answer evaluation section 123 inputs the prompt to the natural language processing section 126 (Step S503), and acquires answer text including an answer evaluation result (Step S504).

The answer evaluation section 123 registers the answer evaluation result in the answer DB 133 (Step S505), and then ends the answer evaluating processing.

Specifically, the answer evaluation section 123 sets, with reference to the table 510, the answer evaluation result of the evaluation item 512 of the entry having the ID 511 that has been set to the entry ID stored in the work area.

Note that evaluation of the satisfaction status of “Consistency” may be performed by the answer evaluation section 123. For example, the answer evaluation section 123 performs morphological analysis with respect to the acquired answer and the last answer to extract words, compute embedding of the words, and compute a temporal change in the embedding. When the temporal change is small, the answer evaluation section 123 determines that “Consistency” is satisfied.

As described with respect to FIG. 14, the meeting apparatus 100 utilizes the natural language processing section 126, and thus can evaluate the satisfaction status of the evaluation item with high precision.

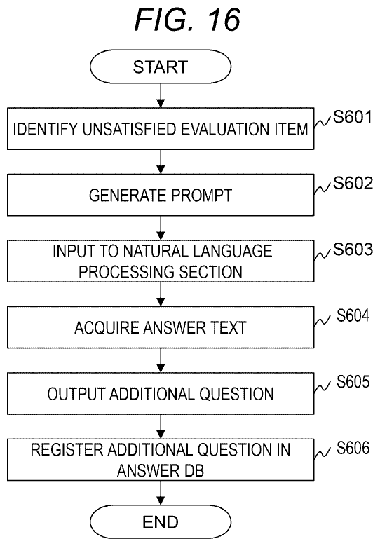

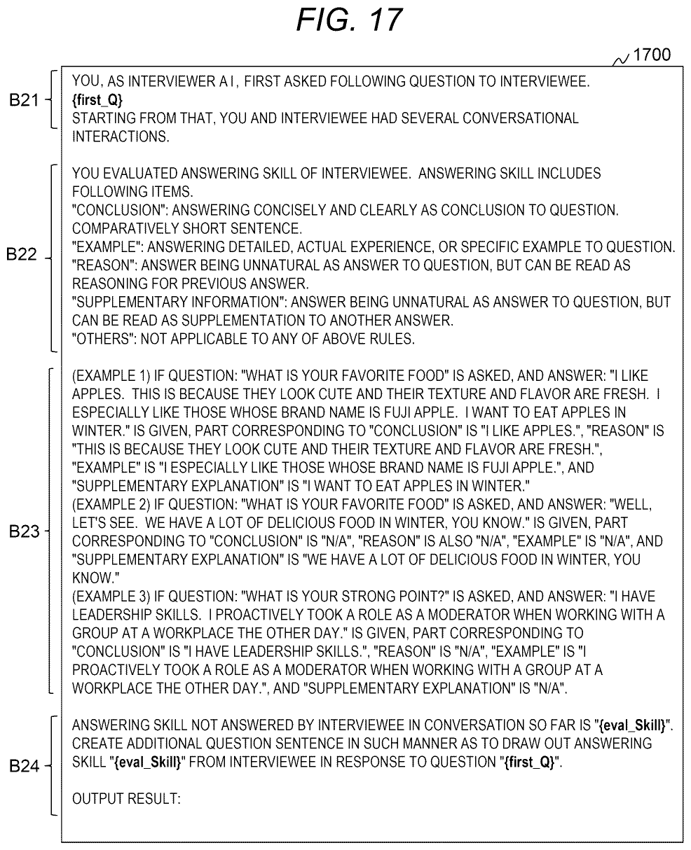

FIG. 16 is a flowchart for explaining one example of the additional-question generating processing that is executed by the meeting apparatus 100 of Embodiment 1. FIG. 17 is a diagram illustrating one example of a prompt that is generated by the meeting apparatus 100 of Embodiment 1.

The additional-question generation section 124 identifies, with reference to the table 510 of the answer DB 133, an unsatisfied evaluation item (Step S601). Specifically, processing as described below is executed.

(S601-1) The additional-question generation section 124 searches, with reference to the table 500, an entry having the reference question ID 502 set to the reference question ID stored in the work area. The additional-question generation section 124 acquires an entry ID from the ID 501 of the searched entry.

(S601-2) The additional-question generation section 124 reads, with reference to the table 510, an entry having the ID 511 set to the acquired entry ID.

(S601-3) The additional-question generation section 124 identifies the unsatisfied evaluation item based on the evaluation item 512 of the read entry.

Among the evaluation items, “Conclusion”, “Reason”, “Example”, “Situation”, “Task”, “Action”, and “Result” are determined to be satisfied when at least one entry stores the field value “1”. Among the evaluation items, “Consistency” is determined to be satisfied when the field value of the latest entry is “1”. Note that the determination method described above is one example, and the method is not limited to this.

The additional-question generation section 124 generates a prompt to instruct generation of the additional question to satisfy the unsatisfied evaluation item (Step S602).

For example, a prompt 1700 as illustrated in FIG. 17 is generated. The prompt 1700 can be divided into four blocks B21, B22, B23, and B24. The block B21 is a block where the first question is input. The block B22 is a block where the evaluation item to be evaluated is explained. The block B23 is a block where an evaluation case example is described. Contents of the blocks B22 and B23 are changed in accordance with the evaluation policy. The block B24 is a block where contents of an additional-question generation task are described. The unsatisfied evaluation item is input in the block B24. Note that the prompt 1700 may include the personal history information of the evaluatee. Accordingly, the additional question in consideration of the unsatisfied evaluation item and the personal history of the evaluatee can be generated.

The additional-question generation section 124 inputs the prompt to the natural language processing section 126 (Step S603), and acquires answer text including the additional question (Step S604).

The additional-question generation section 124 outputs the additional question to the terminal (evaluatee) 101 (Step S605). The meeting conversation presentation unit 141 of the terminal (evaluatee) 101 displays the additional question in the display range 1201 of the screen 1200. Note that the meeting conversation presentation unit 141 may output the additional question as voice or sound.

The additional-question generation section 124 registers the additional question in the answer DB 133 (Step S606). Then, the additional-question generation section 124 ends the additional-question generating processing. Specifically, the additional-question generation section 124 adds an entry to the table 500 associated with the evaluator-and-evaluatee pair, and sets an arbitrary ID as the ID 501. Moreover, the additional-question generation section 124 sets the reference question ID 502 of the entry to the reference question ID stored in the work area. The additional-question generation section 124 sets, as the number of turns 503, a value obtained by adding 1 to the number of turns 503 of the last entry, and sets the additional question as the question 504. At this time, the additional-question generation section 124 updates the entry ID stored in the work area to the entry ID set as the ID 501 of the entry.

As described with respect to FIG. 16, the meeting apparatus 100 utilizes the natural language processing section 126, and thus can generate the additional question to satisfy the unsatisfied evaluation item in consideration of the acquired answer. Therefore, various types of questions in accordance with an answer of an evaluatee can be asked.

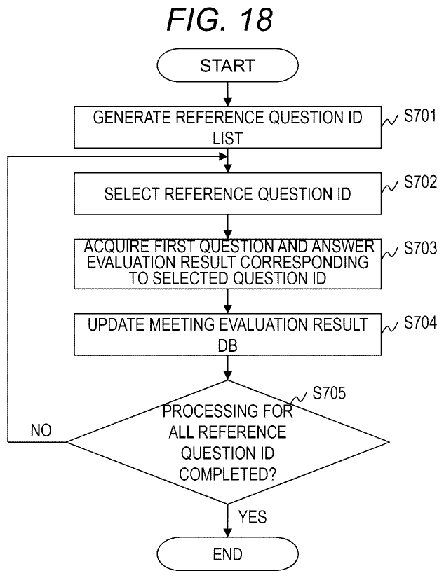

FIG. 18 is a flowchart for explaining one example of the meeting evaluating processing that is executed by the meeting apparatus 100 of Embodiment 1.

The meeting evaluation section 125 generates a list of the reference question ID with reference to the answer DB 133 (Step S701).

Specifically, the meeting evaluation section 125 generates, with reference to the table 500, the list of the reference question ID registered in the table 500.

The meeting evaluation section 125 selects one reference question ID from the list of the reference question ID (Step S702).

The meeting evaluation section 125 acquires the first question corresponding to the selected reference question ID, and the answer evaluation result associated with the first question (Step S703). Specifically, processing as described below is executed.

(S703-1) The meeting evaluation section 125 searches, with reference to the table 500, an entry having the reference question ID 502 set to the selected reference question ID.

(S703-2) The meeting evaluation section 125 acquires the entry ID from the ID 501 of the searched entry. The meeting evaluation section 125 acquires the question (first question) stored in the question 504 of the searched entry whose number of turns 503 is 1.

(S703-4) The meeting evaluation section 125 reads, with reference to the table 510, the entry (answer evaluation result) having the ID 511 set to the acquired entry ID.

The meeting evaluation section 125 updates the meeting evaluation result DB 134 based on the acquired first question and the answer evaluation result associated with the first question (Step S704). Specifically, processing as described below is executed.

(S704-1) The meeting evaluation section 125 adds an entry to the table 600, sets the reference question ID 601 of the added entry to the selected reference question ID, and sets the question 602 to the first question.

(S704-2) The meeting evaluation section 125 merges the evaluation item 512 of the entry (answer evaluation result) read from the table 510, and sets the merged result for the evaluation item 603 of the entry. With respect to one evaluation item, when at least one entry has the field value “1”, the field value of this evaluation item is “1”. With respect to one evaluation item, when no entry has the field value “1”, the field value of this evaluation item is “0”. Note that when a plurality of entries has the field value “1”, only information stored in the latest or oldest entry may be stored, or information stored in all the entries may be stored.

(S704-3) The meeting evaluation section 125 computes a satisfaction score based on the evaluation item 603 of the entry added to the table 600, and sets this satisfaction score as the satisfaction score 604 of the entry.

The meeting evaluation section 125 determines whether processing for all reference question ID registered in the list of the reference question ID is completed (Step S705).

If processing for all reference question ID registered in the list of the reference question ID is not completed, the meeting evaluation section 125 returns to Step S702.

If processing for all reference question ID registered in the list of the reference question ID is completed, the meeting evaluation section 125 ends the meeting evaluating processing.

Next, a method for presenting a meeting result is described.

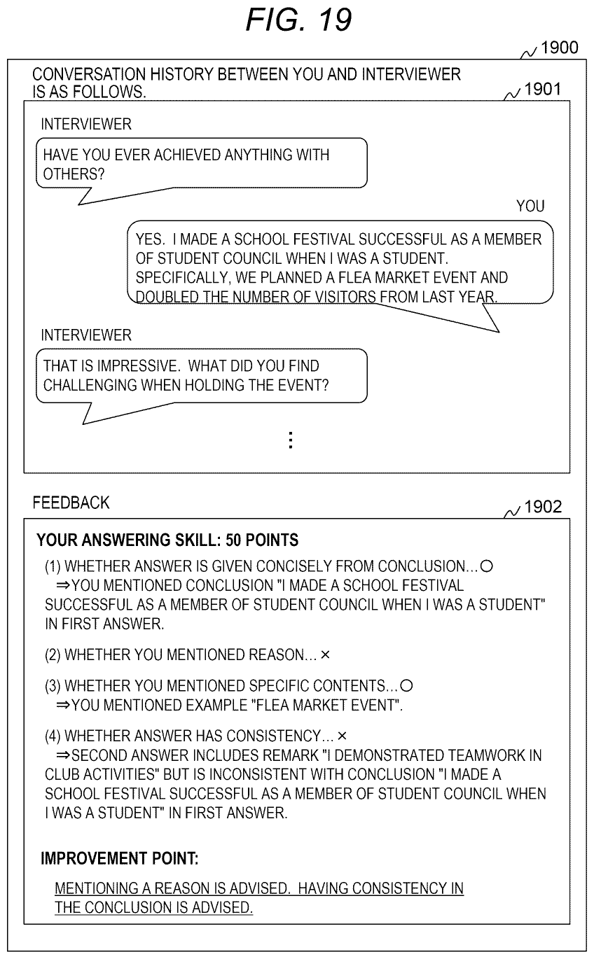

The meeting apparatus 100 feedbacks a meeting result to the evaluatee. FIG. 19 is a diagram illustrating one example of an interface provided to the terminal (evaluatee) 101 of Embodiment 1.

The meeting apparatus 100 displays a screen 1900 as illustrated in FIG. 19 via the feedback presentation unit 143. The screen 1900 includes display ranges 1901 and 1902.

The display range 1901 is a range to display a history of a question and an answer in a meeting. The display range 1901 is displayed based on the table 500 of the answer DB 133.

The display range 1902 is a range to display the evaluation result and feedback of the meeting. The display range 1902 is displayed based on the table 600 of the meeting evaluation result DB 134. Note that the feedback is generated based on the table 600 by the meeting apparatus 100.

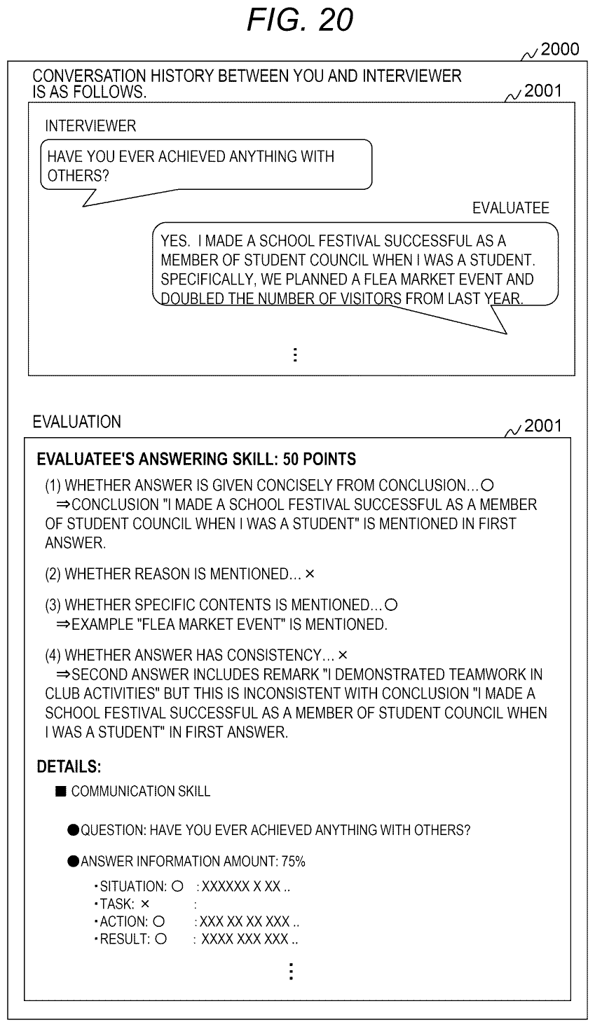

The meeting apparatus 100 outputs a meeting evaluation result to the evaluator. FIG. 20 is a diagram illustrating one example of an interface provided to the terminal (evaluator) 102 of Embodiment 1.

The meeting apparatus 100 displays a screen 2000 as illustrated in FIG. 20 via the meeting-evaluation-result presentation unit 152. The screen 2000 includes display ranges 2001 and 2002.

The display range 2001 is a range to display a history of a question and an answer in a meeting. The display range 2001 is displayed based on the table 500 of the answer DB 133.

The display range 2002 is a range to display the meeting evaluation result. The display range 2002 is displayed based on the table 600 of the meeting evaluation result DB 134.

Note that the present invention is not limited to the embodiment describe above, but includes various modifications. Moreover, for example, in the embodiment, the configurations are described in detail to facilitate understanding of the invention, and the embodiment is not necessarily limited to those including all the described configurations. Moreover, one or some of the configurations of each embodiment can be added to another configuration, deleted, or replaced.

Furthermore, each configuration, function, processing unit, processing device, and the like described above may be implemented by hardware by designing part or all of them by, for example, an integrated circuit. Moreover, the invention can be implemented by a program code of software that implements the function of the embodiment. In this case, a storage medium recording the program code is provided to a computer, and a processor included in the computer reads the program code stored in the storage medium. In this case, the program code itself read from the storage medium implements the function of the above-described embodiment, and the program code itself and the storage medium storing the program code configure the invention. Examples of the storage medium that supplies such a program code include a flexible disk, a CD-ROM, a DVD-ROM, a hard disk, a solid state drive (SSD), an optical disk, a magneto-optical disk, a CD-R, a magnetic tape, a non-volatile memory card, a ROM, and the like.

The program code that implements the function described in this embodiment can be implemented by a wide range of programs or script languages such as an assembler, C/C++, Perl, Shell, PHP, Python, and Java (Registered Trademark).

Further, the program code of software that implements the function of the embodiment may be distributed via a network to be stored in a storage device, such as a hard disk or a memory of a computer, or a storage medium, such as a CD-RW or a CD-R, and a processor included in the computer may read and execute the program code stored in the storage device or the storage medium.

In the embodiment, control lines and information lines indicate what is considered necessary for the explanation, and all control lines and information lines in a product are not necessarily indicated. All configurations may be interconnected.

What is claimed is:

1. A computer system comprising a processor and a storage medium connected to the processor, wherein
the computer system manages an ending condition configured to be set based on a satisfaction status of each of a plurality of evaluation items for determination of quality of information delivery in an answer to a question, and
the processor is configured to:
output a first question to a user who is interviewed in a meeting;
acquire an answer to the first question from the user;
evaluate the satisfaction status of each of the plurality of evaluation items in the answer to the first question and output the evaluated satisfaction status as a first evaluation result;
determine whether the ending condition is satisfied based on the first evaluation result;
when the ending condition is not satisfied, generate an additional question to satisfy the evaluation item not satisfied and output the additional question to the user; and
when the ending condition is satisfied, end accepting of answer input.

2. The computer system according to claim 1, wherein
the processor is configured to:
acquire an answer to the additional question from the user;
determine the satisfaction status of each of the plurality of evaluation items in the answer to the additional question and outputs the determined satisfaction status as a second evaluation result;
determine whether the ending condition is satisfied based on the first evaluation result and the second evaluation result;
when the ending condition is not satisfied, newly generate the additional question and output the newly generated additional question to the user; and
when the ending condition is satisfied, end accepting of answer input.

3. The computer system according to claim 2, wherein
the computer system manages a question list in which the first question comprising a plurality of first questions is registered, and
the processor is configured to:
select one of the first questions from the question list at a start of the meeting; and
when the ending condition is satisfied, select new one of the first questions from the question list.

4. The computer system according to claim 3, wherein
the processor is configured to:
after selecting the new one of the first questions from the question list, correct the new one of the first questions to actively satisfy the evaluation item not satisfied based on the satisfaction status of each of the plurality of evaluation items in the answer to the first question output last time, or based on the satisfaction status of each of the plurality of evaluation items in the answer to the first question output last time and the satisfaction status of each of the plurality of evaluation items in the answer to the additional question; and
output the corrected first question.

5. The computer system according to claim 2, comprising:
a natural language processing program configured to accept input of a prompt in which a content of a task is written, execute the task, and generate answer text comprising an execution result of the task, wherein
the processor is configured to:
identify the evaluation item not satisfied based on the first evaluation result, generate a first prompt comprising the evaluation item not satisfied and a generation instruction of the additional question, and input the first prompt to the natural language processing program; and
identify the evaluation item not satisfied based on the first evaluation result and the second evaluation result, generate a second prompt comprising the evaluation item not satisfied and a generation instruction of the additional question, and input the second prompt to the natural language processing program.

6. The computer system according to claim 5, wherein
the first prompt comprises the first question, the answer to the first question, and the generation instruction of the additional question, and
the second prompt comprises the first question, the answer to the additional question, and the generation instruction of the additional question.

7. The computer system according to claim 6, wherein
the computer system manages personal history information of the user, and
the first prompt and the second prompt comprise the personal history information.

8. The computer system according to claim 2, comprising:
a natural language processing program configured to accept input of a prompt in which a content of a task is written, execute the task, and generate answer text comprising an execution result of the task, wherein
the processor is configured to:
in response to acquisition of the answer to the first question, generate a third prompt to instruct evaluation of the satisfaction status of each of the plurality of evaluation items in the answer to the first question and input the third prompt to the natural language processing program; and
in response to acquisition of the answer to the additional question, generate a fourth prompt to instruct evaluation of the satisfaction status of each of the plurality of evaluation items in the answer to the additional question and input the fourth prompt to the natural language processing program.

9. The computer system according to claim 8, wherein
the third prompt comprises a task content to determine that, when the answer to the first question comprises information on the evaluation item, the evaluation item is satisfied, and
the fourth prompt comprises a task content to determine that, when the answer to the additional question comprises information on the evaluation item, or when the answer to the additional question and an answer to a question output prior to the additional question have consistency therebetween, the evaluation item is satisfied.

10. A dialogue processing method executed by a computer system comprising a processor and a storage medium connected to the processor, wherein
the computer system manages an ending condition configured to be set based on a satisfaction status of each of a plurality of evaluation items for determination of quality of information delivery in an answer to a question, and
the dialogue processing method comprising:
a first step in which the processor outputs a first question to a user who is interviewed in a meeting;
a second step in which the processor acquires an answer to the first question from the user;
a third step in which the processor evaluates the satisfaction status of each of the plurality of evaluation items in the answer to the first question and outputs the evaluated satisfaction status as a first evaluation result;
a fourth step in which the processor determines whether the ending condition is satisfied based on the first evaluation result;
a fifth step in which when the ending condition is not satisfied, the processor generates an additional question to satisfy the evaluation item not satisfied and outputs the additional question to the user; and
a sixth step in which when the ending condition is satisfied, the processor ends accepting of answer input.

11. The dialogue processing method according to claim 10, further comprising:
a seventh step in which the processor acquires an answer to the additional question from the user;
an eighth step in which the processor determines the satisfaction status of each of the plurality of evaluation items in the answer to the additional question and outputs the determined satisfaction status as a second evaluation result;
a ninth step in which the processor determines whether the ending condition is satisfied based on the first evaluation result and the second evaluation result;
a tenth step in which when the ending condition is not satisfied, the processor newly generates the additional question and output the newly generated additional question to the user; and
an eleventh step in which when the ending condition is satisfied, the processor ends accepting of answer input.

12. The dialogue processing method according to claim 11, wherein
the computer system manages a question list in which the first question comprising a plurality of first questions is registered,
the dialogue processing method further comprises:
a twelfth step in which the processor selects one of the first questions from the question list at a start of the meeting; and
a thirteenth step in which when the ending condition is satisfied, the processor selects new one of the first questions from the question list, and
the thirteenth step comprises:
a step in which the processor corrects the new one of the first questions to actively satisfy the evaluation item not satisfied based on the satisfaction status of each of the plurality of evaluation items in the answer to the first question output last time, or based on the satisfaction status of each of the plurality of evaluation items in the answer to the first question output last time and the satisfaction status of each of the plurality of evaluation items in the answer to the additional question; and
a step in which the processor outputs the corrected first question.

13. The dialogue processing method according to claim 11, wherein
the computer system comprises a natural language processing program configured to accept input of a prompt in which a content of a task is written, execute the task, and generate answer text comprising an execution result of the task,
the fifth step comprises a step in which the processor identifies the evaluation item not satisfied based on the first evaluation result, generates a first prompt comprising the evaluation item not satisfied and a generation instruction of the additional question, and inputs the first prompt to the natural language processing program, and
the tenth step comprising step in which the processor identifies the evaluation item not satisfied based on the first evaluation result and the second evaluation result, generates a second prompt comprising the evaluation item not satisfied and a generation instruction of the additional question, and inputs the second prompt to the natural language processing program.

14. The dialogue processing method according to claim 11, wherein
the computer system comprises a natural language processing program configured to accept input of a prompt in which a content of a task is written, execute the task, and generate answer text comprising an execution result of the task,
the third step comprises a step in which in response to acquisition of the answer to the first question, the processor generates a third prompt to instruct evaluation of the satisfaction status of each of the plurality of evaluation items in the answer to the first question and inputs the third prompt to the natural language processing program, and
the eight step comprises a step in which in response to acquisition of the answer to the additional question, the processor generates a fourth prompt to instruct evaluation of the satisfaction status of each of the plurality of evaluation items in the answer to the additional question and inputs the fourth prompt to the natural language processing program.

15. A non-transitory computer-readable storage medium storing a program for causing a computer to execute processing, the computer comprising a processor and the non-transitory computer-readable storage medium connected to the processor, wherein
the computer manages an ending condition configured to be set based on a satisfaction status of each of a plurality of evaluation items for determination of quality of information delivery in an answer to a question, and
the program is configured to cause the computer to execute:
processing to output a first question to a user who is interviewed in a meeting;
processing to acquire an answer to the first question from the user,
processing to evaluate a satisfaction status of each of the plurality of evaluation items in the answer to the first question and output the evaluated satisfaction status as a first evaluation result;
processing to determine whether the ending condition is satisfied based on the first evaluation result;
processing to, when the ending condition is not satisfied, generate an additional question to satisfy the evaluation item not satisfied and output the additional question to the user; and
processing to, when the ending condition is satisfied, end accepting of answer input.
